(19) United States
(12) Patent Application Publication
(10) Pub. No.: US 2024/0239221 A1
(43) Pub. Date: Jul. 18, 2024

(54) ELECTRICALLY-POWERED VEHICLE TRAILER

(71) Applicant: MATT GALLIPEAU, Edmonton (CA)

(72) Inventor: MATT GALLIPEAU, Edmonton (CA)

(21) Appl. No.: 18/097,568

(22) Filed: Jan. 17, 2023

(51) Int. Cl. B60L 53/30; B60K 1/02; B60K 7/00; B60L 15/20; B60L 50/60

(52) U.S. Cl. CPC B60L 53/30; B60K 1/02; B60K 7/0007; B60L 15/20; B60L 50/60; B60L 2200/16; B60L 2200/28

(57) ABSTRACT

The electrically powered vehicle trailer is a supplemental power system for a trailer. The electrically powered vehicle trailer comprises a trailer, a drive structure, and an energy conversion structure. The drive structure and the energy conversion structure mount on the trailer. The drive structure electrically connects to the energy conversion structure. The drive structure draws electric energy from the energy conversion structure to assist in the acceleration of the trailer. The drive structure converts the mechanical energy that decelerates the trailer into electric energy that is transmitted back to the energy conversion structure. The energy conversion structure converts electromagnetic radiation and the energy received from the drive structure into chemical potential energy. The energy conversion structure converts the chemical potential energy into electric energy that is transmitted to the drive structure. The electrically powered vehicle trailer is independently powered.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of trailers with ground wheels driven from a propulsion unit on trailer. (B62D59/04)

### SUMMARY OF INVENTION

The electrically powered vehicle trailer is a supplemental power system for a trailer. The electrically powered vehicle trailer comprises a trailer, a drive structure, and an energy conversion structure. The drive structure and the energy conversion structure mount on the trailer. The drive structure electrically connects to the energy conversion structure. The drive structure draws electric energy from the energy conversion structure to assist in the acceleration of the trailer. The drive structure converts the mechanical energy that decelerates the trailer into electric energy that is transmitted back to the energy conversion structure. The energy conversion structure converts electromagnetic radiation and the energy received from the drive structure into chemical potential energy. The energy conversion structure converts the chemical potential energy into electric energy that is transmitted to the drive structure. The electrically powered vehicle trailer is independently powered. By independently powered is meant that the electrically powered vehicle trailer does not require an electrical connection to an externally provided source of electric energy for operation.

These together with additional objects, features and advantages of the electrically powered vehicle trailer will be readily apparent to those of ordinary skill in the art upon reading the following detailed description of the presently preferred, but nonetheless illustrative, embodiments when taken in conjunction with the accompanying drawings.

In this respect, before explaining the current embodiments of the electrically powered vehicle trailer in detail, it is to be understood that the electrically powered vehicle trailer is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the electrically powered vehicle trailer.

It is therefore important that the claims be regarded as including such equivalent construction insofar as they do not depart from the spirit and scope of the electrically powered vehicle trailer. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a side view of an embodiment of the disclosure.

FIG. 2 is a rear view of an embodiment of the disclosure.

FIG. 3 is a top view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

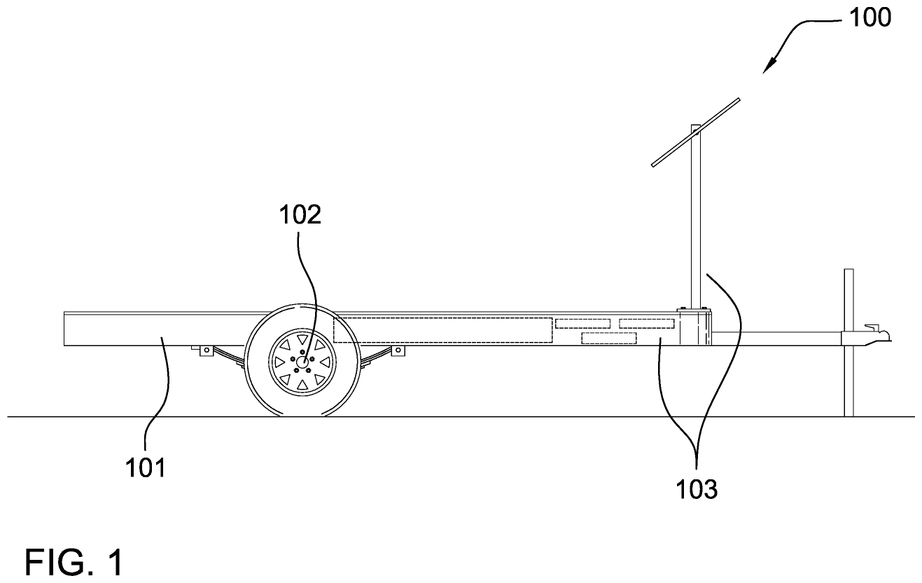

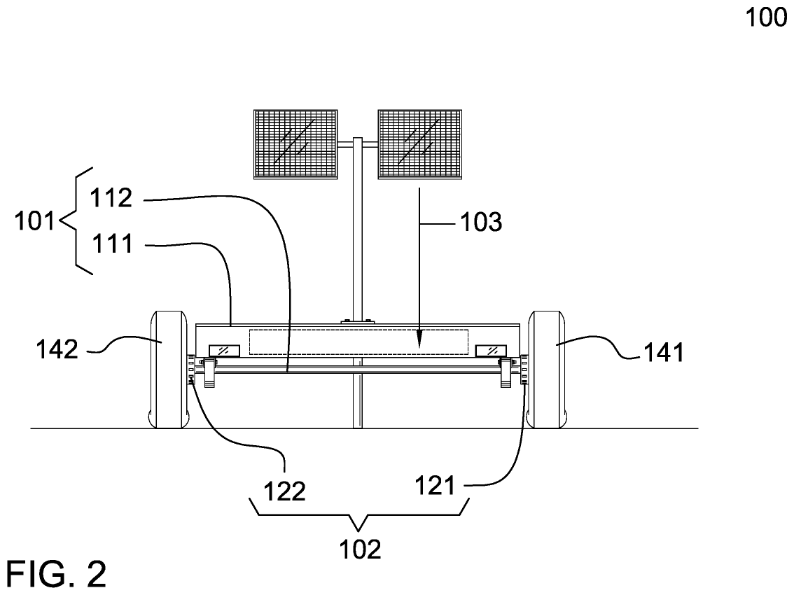

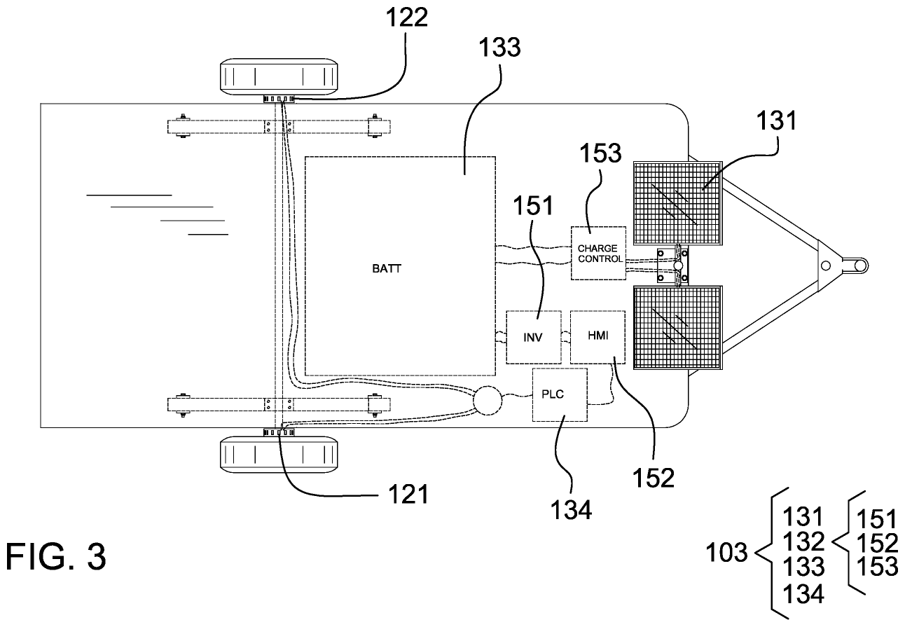

Detailed reference will now be made to one or more potential embodiments of the disclosure, which are illustrated in FIGS. 1 through 3.

The electrically powered vehicle trailer 100 (hereinafter invention) is a supplemental power system for a trailer 101. The invention 100 comprises a trailer 101, a drive structure 102, and an energy conversion structure 103. The drive structure 102 and the energy conversion structure 103 mount on the trailer 101. The drive structure 102 electrically connects to the energy conversion structure 103. The drive structure 102 draws electric energy from the energy conversion structure 103 to assist in the acceleration of the trailer 101. The drive structure 102 converts the mechanical energy that decelerates the trailer 101 into electric energy that is transmitted back to the energy conversion structure 103. The energy conversion structure 103 converts electromagnetic radiation and the energy received from the drive structure 102 into chemical potential energy. The energy conversion structure 103 converts the chemical potential energy into electric energy that is transmitted to the drive structure 102. The invention 100 is independently powered. By independently powered is meant that the invention 100 does not require an electrical connection to an externally provided source of electric energy for operation.

The trailer 101 is a vehicle. The trailer 101 is configured for use in carrying cargo. The trailer 101 is configured for use on a road network. The trailer 101 is an unmotorized vehicle. The trailer 101 is a towed vehicle. The trailer 101 comprises a bed structure 111 and an axle 112. The axle 112 further comprises a first wheel 141 and a second wheel 142.

The bed structure 111 is a horizontally oriented surface. The bed structure 111 is a load bearing surface. The bed structure 111 carries the cargo that is borne by the trailer 101.

The first wheel 141 is a wheel that attaches to the axle 112. The first wheel 141 is a load bearing structure that transfers the load of the trailer 101 to a supporting surface. The first wheel 141 is a rotating structure. The rotation of the first wheel 141 allows the trailer 101 to roll over the supporting surface.

The second wheel 142 is a wheel that attaches to the axle 112. The second wheel 142 is a load bearing structure that transfers the load of the trailer 101 to a supporting surface. The second wheel 142 is a rotating structure. The rotation of the second wheel 142 allows the trailer 101 to roll over the supporting surface.

The axle 112 is a prism shaped structure. The axle 112 is a rigid structure. The axle 112 forms the mechanical structure that secures the first wheel 141 and the second wheel 142 to the undercarriage of the trailer 101. The first wheel 141 attaches to a first congruent end of the prism structure of the axle 112. The second wheel 142 attaches to a second congruent end of the prism structure of the axle 112. The second wheel 142 attaches to the congruent end of the axle 112 that is distal from the first wheel 141.

The drive structure 102 is an electromechanical device. The drive structure 102 receives electric energy from the energy conversion structure 103. The drive structure 102 converts electric energy into rotational energy. The rotational energy generated by the drive structure 102 is transferred to the first wheel 141 of the axle 112 to aid in the acceleration of the trailer 101. The rotational energy generated by the drive structure 102 is transferred to the second wheel 142 of the axle 112 to aid in the acceleration of the trailer 101.

The drive structure 102 converts excess rotational energy generated by the first wheel 141 during the deceleration of the trailer 101 into electric energy that is transmitted to the energy conversion structure 103. The drive structure 102 converts excess rotational energy generated by the second wheel 142 during the deceleration of the trailer 101 into electric energy that is transmitted to the energy conversion structure 103. The drive structure 102 transmits the electric energy generated from the first wheel 141 and the second wheel 142 to the energy conversion structure 103. The energy conversion structure 103 converts the electric energy received from the drive structure 102 into chemical potential energy.

The drive structure 102 comprises a first electric motor 121 and a second electric motor 122.

The first electric motor 121 is an electric motor. The first electric motor 121 attaches to the first congruent end of the axle 112. The first electric motor 121 attaches to the first wheel 141 of the axle 112. The first electric motor 121 converts electric energy into rotational energy that is transferred to the first wheel 141. The rotational energy generated by the first electric motor 121 aids in the acceleration of the trailer 101. The first electric motor 121 converts excess rotational energy generated by the deceleration of the trailer 101 into electric energy. The electric energy generated by the first electric motor 121 is transmitted to the energy conversion structure 103 for conversion into and storage as chemical potential energy.

The second electric motor 122 is an electric motor. The second electric motor 122 attaches to the first congruent end of the axle 112. The second electric motor 122 attaches to the second wheel 142 of the axle 112. The second electric motor 122 converts electric energy into rotational energy that is transferred to the second wheel 142. The rotational energy generated by the second electric motor 122 aids in the acceleration of the trailer 101. The second electric motor 122 converts excess rotational energy generated by the deceleration of the trailer 101 into electric energy. The electric energy generated by the second electric motor 122 is transmitted to the energy conversion structure 103 for conversion into and storage as chemical potential energy.

The energy conversion structure 103 is an energy conversion device. The energy conversion structure 103 is an energy storage device. The energy conversion structure 103 is an electrochemical device. The energy conversion structure 103 stores chemical potential energy. The energy conversion structure 103 converts the stored electrochemical energy into electric energy. The energy conversion structure 103 transmits the generated electric energy to the first electric motor 121 of the drive structure 102. The energy conversion structure 103 transmits the generated electric energy to the second electric motor 122 of the drive structure 102.

The energy conversion structure 103 converts electromagnetic radiation into electric energy. The energy conversion structure 103 converts the electric energy received from the electromagnetic radiation into chemical potential energy for storage. The energy conversion structure 103 receives electric energy from the drive structure 102 that has been regenerated by the deceleration of the trailer 101. The energy conversion structure 103 converts the electric energy received from the drive structure 102 into chemical potential energy for storage.

The energy conversion structure 103 is independently powered. By independently powered is meant that the energy conversion structure 103 is capable of supporting the energy requirements of the invention 100 without requiring an electric connection to an external power source.

The energy conversion structure 103 comprises a photovoltaic cell structure 131, a conversion circuit structure, an energy storage structure 133, and a motor control structure 134. The photovoltaic cell structure 131, the conversion circuit structure, the energy storage structure 133, and the motor control structure 134 are electrically interconnected.

The photovoltaic cell structure 131 is an electric device. The photovoltaic cell structure 131 mounts on the bed structure 111 of the trailer 101. The photovoltaic cell structure 131 is positioned within the field of illumination of the electromagnetic radiation generated by the sun. The photovoltaic cell structure 131 converts any captured electromagnetic radiation into electric energy. The photovoltaic cell structure 131 transmits the converted electric energy to the conversion circuit structure.

The conversion circuit structure is an electric circuit. The conversion circuit structure converts electric energy received from the photovoltaic cell structure 131 into chemical potential energy. The conversion circuit structure converts electric energy received from the drive structure 102 into chemical potential energy. The conversion circuit structure stores the converted chemical potential energy in the energy storage structure 133. The conversion circuit structure converts the chemical potential energy stored in the energy storage structure 133 into electric energy. The conversion circuit structure transmits the electric energy derived from the chemical potential energy to the first electric motor 121. The conversion circuit structure transmits the electric energy derived from the chemical potential energy to the second electric motor 122.

The conversion circuit structure comprises an inverter 151, an ac/dc converter 152, and a rectifier 153. The inverter 151 electrically connects to the energy storage structure 133. The ac/dc converter 152 electrically connects to the energy storage structure 133. The rectifier 153 electrically connects to the energy storage structure 133.

The inverter 151 is an electric circuit. The inverter 151 draws dc electric energy directly from the energy storage structure 133 of the energy conversion structure 103. The inverter 151 converts the drawn dc energy into ac energy before the ac electric energy is transmitted to the drive structure 102. The inverter 151 is defined elsewhere in this disclosure.

The ac/dc converter 152 is an electric circuit. The ac/dc converter 152 receives ac electric energy from the drive structure 102. The ac/dc converter 152 converts the received ac electric energy into dc electric energy before the dc electric energy is transmitted to the energy storage structure 133 for conversion into chemical potential energy. The ac/dc converter 152 is defined elsewhere in this disclosure.

The rectifier 153 is an electric circuit. The rectifier 153 forms a diode structure that prevents the flow of electric energy from the energy storage structure 133 into the photovoltaic cell structure 131.

The energy storage structure 133 is an electrochemical device. The energy storage structure 133 stores chemical potential energy. The energy storage structure 133 converts chemical potential energy into electric energy. The energy storage structure 133 is a rechargeable structure. By rechargeable is meant that the energy storage structure 133 converts electric energy back into chemical potential energy.

The motor control structure 134 is an electric circuit. The motor control structure 134 electrically connects to the first electric motor 121. The motor control structure 134 electrically connects to the second electric motor 122.

The motor control structure 134 controls the operation of the first electric motor 121. By controlling the operation of the first electric motor 121 is meant that: a) the motor control structure 134 controls the direction of rotation of the first electric motor 121; and, b) the motor control structure 134 controls the speed of rotation of the first electric motor 121. The motor control structure 134 controls the operation of the second electric motor 122. By controlling the operation of the second electric motor 122 is meant that: a) the motor control structure 134 controls the direction of rotation of the second electric motor 122; and, b) the motor control structure 134 controls the speed of rotation of the second electric motor 122.

The motor control structure 134 maintains a predetermined voltage across the first electric motor 121. The motor control structure 134 converts any overvoltage across the first electric motor 121 into electric energy that is transmitted to the conversion circuit structure. The motor control structure 134 draws electric energy from the conversion circuit structure to feed the first electric motor 121 when the motor control structure 134 detects an undervoltage across the first electric motor 121.

The motor control structure 134 maintains a predetermined voltage across the second electric motor 122. The motor control structure 134 converts any overvoltage across the second electric motor 122 into electric energy that is transmitted to the conversion circuit structure. The motor control structure 134 draws electric energy from the conversion circuit structure to feed the second electric motor 122 when the motor control structure 134 detects an undervoltage across the second electric motor 122.

The following definitions were used in this disclosure:
AC: As used in this disclosure, AC is an acronym for alternating current.
AC/DC Converter: As used in this disclosure, an AC/DC converter is an electrical device that converts an AC voltage into a regulated DC voltage by rectifying and regulating the AC voltage. Method to design and build AC/DC converters are well known in the electrical arts. The AC/DC converter is further defined with a positive terminal, a negative terminal, and a power input.
Bed: As used in this disclosure, a bed refers to a horizontally oriented surface that forms the supporting surface for a load.
Bluetooth™: As used in this disclosure, Bluetooth™ is a standardized communication protocol that is used to wirelessly interconnect electronic devices.
Battery: As used in this disclosure, a battery is a chemical device consisting of one or more cells, in which chemical energy is converted into electricity and used as a source of power. Batteries are commonly defined with a positive terminal and a negative terminal.
Cargo: As used in this disclosure, cargo refers to one or more objects that are intended to be transported using a vehicle. The term freight is a synonym for cargo.
Channel: As used in this disclosure, a channel is a previously determined frequency of electromagnetic radiation that is used for wireless communication. Wireless communication structures often designate a plurality of channels which allows users to “change the channel” when a previously specified channel is experiencing some form of interference.
Communication Link: As used in this disclosure, a communication link refers to the structured exchange of data between two objects.
Control Circuit: As used in this disclosure, a control circuit is an electrical circuit that manages and regulates the behavior or operation of a device.
DC: As used in this disclosure, DC is an acronym for direct current.
Diode: As used in this disclosure, a diode is a two terminal semiconductor device that allows current flow in only one direction. The two terminals are called the anode and the cathode. Electric current is allowed to pass from the anode to the cathode.
Electric Motor: In this disclosure, an electric motor is a machine that converts electric energy into rotational mechanical energy. An electric motor typically comprises a stator and a rotor. The stator is a stationary hollow cylindrical structure that forms a magnetic field. The rotor is a magnetically active rotating cylindrical structure that is coaxially mounted in the stator. The magnetic interactions between the rotor and the stator physically causes the rotor to rotate within the stator thereby generating rotational mechanical energy. This disclosure assumes that the power source is an externally provided source of DC electrical power. The use of DC power is not critical and AC power can be used by exchanging the DC electric motor with an AC motor that has a reversible starter winding.
External Power Source: As used in this disclosure, an external power source is a source of the energy that is externally provided to enable the operation of the present disclosure. Examples of external power sources include, but are not limited to, electrical power sources and compressed air sources.
Field of Illumination: As used in this disclosure, a field of illumination refers to an area illuminated by electromagnetic radiation projected from an electrical device such as a lamp or transmission antenna.
Generator: In this disclosure, a generator is a machine that converts rotational mechanical energy into electric energy. A generator typically comprises a stator and a rotor. The stator is a stationary hollow cylindrical structure that forms a magnetic field. The rotor is a rotating cylindrical structure that is coaxially mounted in the stator. The rotation of the rotor within the stator physically generates the electrical energy. A generator can generate an electrical voltage selected from the group consisting of an AC voltage and a DC voltage. When a DC voltage is generated, this disclosure assumes that the term generator includes commutator and electrical circuitry required to generate a regulated DC voltage.
Interface: As used in this disclosure, an interface is a physical or virtual boundary that separates two different systems and across which occurs an exchange.
Inverter: As used in this disclosure, an inverter is an electrical device that converts a DC voltage into an AC voltage. Methods to design and build inverters are well known in the electrical arts. An inverter is also known as a frequency generator.
Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs. The disclosure allows, but does not assume, that the logic module is programmable.
Messaging Facility: As used in this disclosure, a messaging facility is a previously determined formatting structure through which a text or image (referred to in this definition as text) based communication is transmitted for delivery. A messaging facility is selected from the group consisting of a traditional messaging facility, a direct messaging facility and a broadcast messaging facility. A traditional messaging facility includes the delivery of a physical object containing the text based communication. The direct messaging facility includes communications that are addressed to a previously identified group of recipients. The broadcast messaging facility includes communications that are transmitted without the prior identification of the intended group of recipients. An example of a traditional messaging facility includes, but is not limited to, postal delivery. Examples of a direct messaging facilities include, but are not limited to, email, audio based communications, and SMS messages. A social media service is an example of a broadcast messaging facility.
Motor: As used in this disclosure, a motor refers to the method of transferring energy from an external power source into rotational mechanical energy.
Motor Controller: As used in this disclosure, a motor controller is an electrical device that is used to control the rotational speed, or simply the speed, and the direction of rotation of an electric motor. Motor controllers will generally receive one or more inputs which are used determine the desired rotational speed and direction of rotation of the electric motor.
PDD: As used in this disclosure, PDD is an acronym for personal data device.
Personal Data Device: As used in this disclosure, a personal data device is a handheld logical device that is used for managing personal information and communication. Examples of personal data device include, but are not limited to, cellular phones, tablets, and smartphones.
Plug: As used in this disclosure, a plug is an electrical termination that electrically connects a first electrical circuit to a second electrical circuit or a source of electricity. As used in this disclosure, a plug will have two or three metal pins.
Port: As used in this disclosure, a port is an electrical termination that is used to connect a first electrical circuit to a second external electrical circuit. In this disclosure, the port is designed to receive a plug.
Photoelectric: As used in this disclosure, photoelectric is an adjective used to describe an electronic component in which the performance of the electronic component is modified by light. Typical photoelectric devices include, but are not limited to, photoelectric transistors, photoelectric diodes, and photoelectric resistors.
Photovoltaic Cell: As used in this disclosure, a photovoltaic cell is a photoelectric device that directly converts light energy into electrical energy.
Tractor: As used in this disclosure, a tractor refers to a vehicle that is used to tow a trailer.
Trailer: As used in this disclosure, a trailer is an unpowered wheeled vehicle that is towed by a powered vehicle such as a tractor.
Tow: As used in this disclosure, the term tow is used as a verb that refers to moving an object by pulling on the object with the assistance of an apparatus or device.
Undercarriage: As used in this disclosure, the undercarriage refers to the substructure of a vehicle that comprises the wheels and the attachment of the wheels to the rest of the vehicle.
Unregulated Voltage: This refers to a source of DC voltage that changes in response to changes to the circuit's input power supply voltage or to changes in output, or load current.
Volt: As used in this disclosure, a volt refers to the difference in electrical potential energy between two points in an electric circuit. A volt is measured as joules per coulomb. The term voltage refers to a quantitative measure of the volts between the two points.
Voltage Regulator: As used in this disclosure, a voltage regulator refers to an electrical circuit that takes unregulated voltage as its power input and provides a constant output voltage independent of variations to input power supply voltage or output, or load, current.
WiFi™: As used in this disclosure, WiFi™ refers to the physical implementation of a collection of wireless electronic communication standards commonly referred to as IEEE 802.11x.
Wireless: As used in this disclosure, wireless is an adjective that is used to describe a communication link between two devices that does not require the use of physical cabling.
Wireless Communication Link: As used in this disclosure, a wireless communication link is a previously determined channel that is used to wirelessly exchange information between one or more transceivers.
Wireless Communication Establishment Technology: As used in this disclosure, a wireless communication establishment technology refers to technology that establishes a wireless communication link between a first logical device and a second logical device. Usually, the operation of a wireless communication establishment technology is initiated by the push of a button. An example of such a technology is the WiFi™ protected setup technology (WPS™)

With respect to the above description, it is to be realized that the optimum dimensional relationship for the various components of the invention described above and in FIGS. 1 through 3 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An electrically powered vehicle trailer comprising
a trailer, a drive structure, and an energy conversion structure;
wherein the drive structure and the energy conversion structure mount on the trailer;
wherein the drive structure electrically connects to the energy conversion structure.

2. The electrically powered vehicle trailer according to claim 1
wherein the electrically powered vehicle trailer is a supplemental power system for a trailer;
wherein the drive structure draws electric energy from the energy conversion structure to assist in the acceleration of the trailer;
wherein the drive structure converts the mechanical energy that decelerates the trailer into electric energy that is transmitted back to the energy conversion structure;
wherein the energy conversion structure converts electromagnetic radiation and the energy received from the drive structure into chemical potential energy;
wherein the energy conversion structure converts the chemical potential energy into electric energy that is transmitted to the drive structure.

3. The electrically powered vehicle trailer according to claim 2
wherein the electrically powered vehicle trailer is independently powered;
wherein by independently powered is meant that the electrically powered vehicle trailer does not require an electrical connection to an externally provided source of electric energy for operation.

4. The electrically powered vehicle trailer according to claim 3
wherein the trailer comprises a bed structure and an axle;
wherein the axle further comprises a first wheel and a second wheel;
wherein the bed structure is a horizontally oriented surface;
wherein the bed structure is a load bearing surface;
wherein the first wheel is a wheel that attaches to the axle;
wherein the first wheel is a load bearing structure that transfers the load of the trailer to a supporting surface;
wherein the first wheel is a rotating structure;
wherein the second wheel is a wheel that attaches to the axle;
wherein the second wheel is a load bearing structure that transfers the load of the trailer to a supporting surface;
wherein the second wheel is a rotating structure;
wherein the axle is a rigid structure;
wherein the axle forms the mechanical structure that secures the first wheel and the second wheel to the undercarriage of the trailer;
wherein the first wheel attaches to a first congruent end of the axle;
wherein the second wheel attaches to a second congruent end of the axle;
wherein the second wheel attaches to the congruent end of the axle that is distal from the first wheel.

5. The electrically powered vehicle trailer according to claim 4
wherein the drive structure is an electromechanical device;
wherein the drive structure receives electric energy from the energy conversion structure;
wherein the drive structure converts electric energy into rotational energy;
wherein the rotational energy generated by the drive structure is transferred to the first wheel of the axle to aid in the acceleration of the trailer;
wherein the rotational energy generated by the drive structure is transferred to the second wheel of the axle to aid in the acceleration of the trailer;
wherein the drive structure converts excess rotational energy generated by the first wheel during the deceleration of the trailer into electric energy that is transmitted to the energy conversion structure;
wherein the drive structure converts excess rotational energy generated by the second wheel during the deceleration of the trailer into electric energy that is transmitted to the energy conversion structure;
wherein the drive structure transmits the electric energy generated from the first wheel and the second wheel to the energy conversion structure;
wherein the energy conversion structure converts the electric energy received from the drive structure into chemical potential energy.

6. The electrically powered vehicle trailer according to claim 5
wherein the energy conversion structure is an energy conversion device;
wherein the energy conversion structure is an energy storage device;
wherein the energy conversion structure is an electrochemical device;
wherein the energy conversion structure stores chemical potential energy;
wherein the energy conversion structure converts the stored electrochemical energy into electric energy;
wherein the energy conversion structure transmits the generated electric energy to the first electric motor of the drive structure;
wherein the energy conversion structure transmits the generated electric energy to the second electric motor of the drive structure;
wherein the energy conversion structure converts electromagnetic radiation into electric energy;
wherein the energy conversion structure converts the electric energy received from the electromagnetic radiation into chemical potential energy for storage;
wherein the energy conversion structure receives electric energy from the drive structure that has been regenerated by the deceleration of the trailer;
wherein the energy conversion structure converts the electric energy received from the drive structure into chemical potential energy for storage;
wherein the energy conversion structure is independently powered;
wherein by independently powered is meant that the energy conversion structure is capable of supporting the energy requirements of the electrically powered vehicle trailer without requiring an electric connection to an external power source.

7. The electrically powered vehicle trailer according to claim 6
wherein the drive structure comprises a first electric motor and a second electric motor;
wherein the first electric motor is an electric motor;
wherein the first electric motor attaches to the first congruent end of the axle;
wherein the first electric motor attaches to the first wheel of the axle;
wherein the second electric motor is an electric motor;
wherein the second electric motor attaches to the first congruent end of the axle;
wherein the second electric motor attaches to the second wheel of the axle.

8. The electrically powered vehicle trailer according to claim 7
wherein the energy conversion structure comprises a photovoltaic cell structure, a conversion circuit structure, an energy storage structure, and a motor control structure;
wherein the photovoltaic cell structure, the conversion circuit structure, the energy storage structure, and the motor control structure are electrically interconnected.

9. The electrically powered vehicle trailer according to claim 8
wherein the first electric motor converts electric energy into rotational energy that is transferred to the first wheel;
wherein the rotational energy generated by the first electric motor aids in the acceleration of the trailer;
wherein the first electric motor converts excess rotational energy generated by the deceleration of the trailer into electric energy;
wherein the electric energy generated by the first electric motor is transmitted to the energy conversion structure for conversion into and storage as chemical potential energy;
wherein the second electric motor converts electric energy into rotational energy that is transferred to the second wheel;
wherein the rotational energy generated by the second electric motor aids in the acceleration of the trailer;
wherein the second electric motor converts excess rotational energy generated by the deceleration of the trailer into electric energy;
wherein the electric energy generated by the second electric motor is transmitted to the energy conversion structure for conversion into and storage as chemical potential energy.

10. The electrically powered vehicle trailer according to claim 9
wherein the photovoltaic cell structure is an electric device;
wherein the photovoltaic cell structure mounts on the bed structure of the trailer;
wherein the photovoltaic cell structure is positioned within the field of illumination of the electromagnetic radiation generated by the sun;
wherein the photovoltaic cell structure converts any captured electromagnetic radiation into electric energy;
wherein the photovoltaic cell structure transmits the converted electric energy to the conversion circuit structure.

11. The electrically powered vehicle trailer according to claim 10
wherein the conversion circuit structure is an electric circuit;
wherein the conversion circuit structure converts electric energy received from the photovoltaic cell structure into chemical potential energy;
wherein the conversion circuit structure converts electric energy received from the drive structure into chemical potential energy;
wherein the conversion circuit structure stores the converted chemical potential energy in the energy storage structure;
wherein the conversion circuit structure converts the chemical potential energy stored in the energy storage structure into electric energy;
wherein the conversion circuit structure transmits the electric energy derived from the chemical potential energy to the first electric motor;
wherein the conversion circuit structure transmits the electric energy derived from the chemical potential energy to the second electric motor.

12. The electrically powered vehicle trailer according to claim 11
wherein the energy storage structure is an electrochemical device;
wherein the energy storage structure stores chemical potential energy;
wherein the energy storage structure converts chemical potential energy into electric energy;
wherein the energy storage structure is a rechargeable structure;
wherein by rechargeable is meant that the energy storage structure converts electric energy back into chemical potential energy.

13. The electrically powered vehicle trailer according to claim 12
wherein the motor control structure is an electric circuit;
wherein the motor control structure electrically connects to the first electric motor;
wherein the motor control structure electrically connects to the second electric motor;
wherein the motor control structure controls the operation of the first electric motor;
wherein by controlling the operation of the first electric motor is meant that: a) the motor control structure controls the direction of rotation of the first electric motor; and, b) the motor control structure controls the speed of rotation of the first electric motor;
wherein the motor control structure controls the operation of the second electric motor;
wherein by controlling the operation of the second electric motor is meant that: a) the motor control structure controls the direction of rotation of the second electric motor; and, b) the motor control structure controls the speed of rotation of the second electric motor.

14. The electrically powered vehicle trailer according to claim 13
wherein the conversion circuit structure comprises an inverter, an ac/dc converter, and a rectifier;
wherein the inverter is an electric circuit;
wherein the inverter draws dc electric energy directly from the energy storage structure of the energy conversion structure;
wherein the inverter converts the drawn dc energy into ac energy before the ac electric energy is transmitted to the drive structure;
wherein the ac/dc converter is an electric circuit;
wherein the ac/dc converter receives ac electric energy from the drive structure;
wherein the ac/dc converter converts the received ac electric energy into dc electric energy before the dc electric energy is transmitted to the energy storage structure for conversion into chemical potential energy;
wherein the rectifier is an electric circuit;
wherein the rectifier prevents the flow of electric energy from the energy storage structure into the photovoltaic cell structure.
